(19) United States
(12) Patent Application Publication
(10) Pub. No.: US 2006/0104667 A1
(43) Pub. Date: May 18, 2006

(54) Developing solution carrier and wet type image forming apparatus

(75) Inventor: Hiroyuki Saito, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/274,419

(22) Filed: Nov. 16, 2005

(30) Foreign Application Priority Data
Nov. 18, 2004 (JP) 2004-334226

(51) Int. Cl. G03G 15/10

(52) U.S. Cl. 399/239

(57) ABSTRACT

A developing solution carrier configured to mix developing solution containing therein toner stored in a developing solution tank and convey the developing solution to a predetermined location includes a housing including a first opening connected to the developing solution tank and a second opening formed close to the predetermined location and two rotatable members located inside the housing. The rotatable members are configured to be engaged with each other, so as to generate force at the interface therebetween in a direction toward the second opening from the first opening while rotating.

### BACKGROUND OF THE INVENTION

The present invention relates to a developing solution carrier configured to convey developing solution containing toner in carrier solution to a predetermined location, and to a wet type image forming apparatus, which is provided with such a developing solution carrier, configured to form an image with the developing solution.

Apparatuses that transfer toner to a recording paper to thereby form an image include, for example, a dry type image forming apparatus, which applies powder toner to the surface of a developing roller to form an image, and a wet type image forming apparatus, which applies developing solution containing toner in carrier solution to the surface of a developing roller (more strictly, a “developing solution carrying roller”) to form an image, as disclosed in Japanese Unexamined Patent Publication No. 2000-250318. The toner employed in the latter apparatus is finer than that employed in the former. Accordingly, the latter provides images of higher quality.

In a wet type image forming apparatus as described in Japanese Unexamined Patent Publication. No. 2000-250318, a tube pump is employed to deliver liquid toner (i.e., developing solution) stored in a toner container to a location above an applicator roller. In addition, the toner that has not been consumed for developing is collected into the toner container for recycling. The collected toner is unevenly distributed or aggregated in the solution. Accordingly, the toner container generally includes a mixer for uniformly distributing the toner all over the solution.

In most of conventional wet type image forming apparatuses including the one according to Japanese Unexamined Patent Publication No. 2000-250318, however, the developing solution carrier that conveys the developing solution is complicatedly configured. Besides, the developing solution carrier and the mixer are independently installed from each other. Such a configuration constitutes a bottleneck in reducing the overall dimensions of the wet type image forming apparatus, as well as the manufacturing cost thereof.

### SUMMARY OF THE INVENTION

The present invention is advantageous in that a developing solution carrier with a simple structure, yet capable of both mixing and conveying developing solution, and a wet type image forming apparatus that includes such a developing solution carrier, is provided.

According to an aspect of the invention, there is provided a developing solution carrier configured to mix developing solution containing therein toner stored in a developing solution tank and convey the developing solution to a predetermined location, which includes a housing including a first opening connected to the developing solution tank and a second opening formed close to the predetermined location and two rotatable members located inside the housing, the rotatable members being configured to be engaged with each other, so as to generate force at the interface therebetween in a direction toward the second opening from the first opening while rotating.

Optionally, the rotatable members may be cylindrical-shaped helical members having respective spiral tooth leads formed thereon. Optionally, at least one of the rotatable members may be a helical gear supported by a rotatable shaft.

Optionally, the rotatable members may have the spiral tooth leads formed in different directions from each other.

Still optionally, the engagement ratio of the rotatable members may be gradually increased in a direction toward the second opening from the first opening.

Further optionally, one of the rotatable members may be caused to rotate by rotation of the other.

Optionally, at least one of the rotatable members is formed of elastic material.

Yet optionally, at least one of the rotatable members may be configured with a plurality of rotatable members being joined to one another.

Optionally, at least one of the rotatable members is formed by resin molding.

According to another aspect of the invention, there is provided a wet type image forming apparatus configured to form an image with developing solution containing toner in carrier solution stored in a developing solution tank, which includes a latent image carrying roller on which a latent image to be developed by the toner is formed, a developing solution carrying roller configured to carry the developing solution so as to supply the toner to the latent image carrying roller, a developing solution applicator roller configured to uniformly apply the developing solution to a surface of the developing solution carrying roller, and a developing solution carrier configured to mix the developing solution in the developing solution tank and convey the developing solution toward the developing solution applicator roller. The developing solution carrier includes a housing including a first opening connected to the developing solution tank and a second opening formed above the developing solution applicator roller, and two rotatable members located inside the housing. The rotatable members are configured to be engaged with each other, so as to generate force at the interface therebetween in a direction toward the second opening from the first opening while rotating.

### BRIEF DESCRIPTION OF THE ACCOMPANYING DRAWINGS

FIG. 1 is a schematic cross-sectional side view showing a structure of a wet type printer according to a first embodiment of the present invention;

FIG. 2 is an enlarged cross-sectional side view showing a structure around a developing solution carrier according to the first embodiment of the present invention;

FIG. 3 is a schematic perspective view showing only helical gears and rotating shafts thereof out of the developing solution carrier according to the first embodiment of the present invention;

FIG. 4 is a schematic perspective view showing a helical gear and a helical roller incorporated in a wet type printer according to a second embodiment; and

FIG. 5 is a schematic perspective view showing a helical gear and a helical roller incorporated in a wet type printer according to a third embodiment.

### DETAILED DESCRIPTION OF THE EMBODIMENTS

Hereinafter, referring to the accompanying drawings, wet type printers, which are wet type image forming apparatuses of embodiments according to the present invention, will be described hereunder.

### First Embodiment

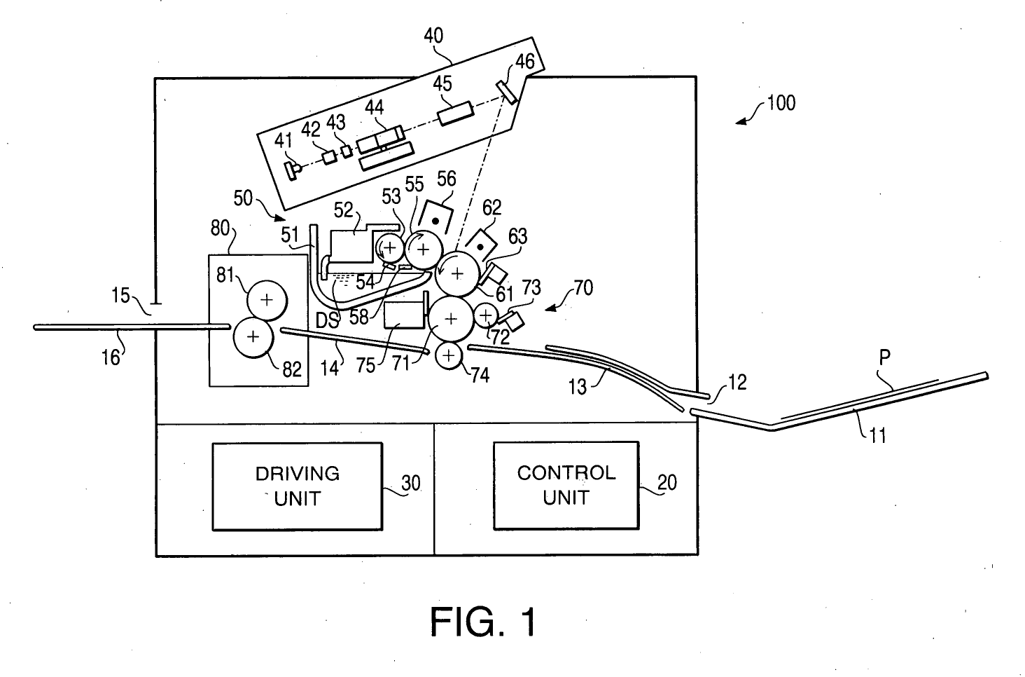

FIG. 1 is a cross-sectional side view showing a structure of a wet type printer 100 according to an embodiment (first embodiment) of the present invention. The wet type printer 100 is an apparatus that forms an image with a developing roller that carries, on its surface, developing solution DS containing toner in carrier solution, and more specifically an apparatus that prints out a letter or image information inputted from an external apparatus such as a computer on a recording paper P by an electrophotography process utilizing a laser beam.

The wet type printer 100 generally includes a control unit 20 that controls a printing process, carrying operation and so on, a driving unit 30 that drives various mechanisms, a laser scanning unit (hereinafter, abbreviated as “LSU”) 40 that outputs a laser beam modulated according to printing information, a developing unit 50 that develops a latent image formed according to a letter or printing information with the developing solution DS by electrophotography, a transfer unit 70 that sets a toner image developed by the developing unit 50 at a transfer position and thereby transfers the image on the recording paper P, a carrying mechanism that carries the recording paper P, and a fixing unit 80 that fixes the toner image transferred onto the recording paper P supplied by the carrying mechanism.

The driving unit 30 serving as a driving source of the mechanisms in the wet type printer 100 includes a plurality of actuators that drive the respective mechanisms. All of these actuators are connected to the control unit 20, to be driven under the control of the control unit 20. The driving unit 30 can cause a rotation of, for example, a developing roller 55 (developing solution carrying roller) and photoconductive drum 61 (latent image carrying roller) included in the developing unit 50, and a heat roller 81 included in the fixing unit 80.

On a side face of a housing of the wet type printer 100, a paper inlet 12 is provided, through which the recording paper P is introduced into the printer, and a paper tray 11 for storing the recording paper P is attached at the paper inlet 12. On the opposite side face of the housing, a paper outlet 15 and a receiver tray 16 are provided. The recording paper P, upon being introduced into the wet type printer 100 through the paper inlet 12, is carried along a paper path 13 to reach the transfer position defined by the transfer unit 70, where the toner is transferred onto the surface of the recording paper P according to the printing information. Thereafter the recording paper P is carried along a paper path 14 to reach a fixing position defined by the fixing unit 80 for fixation of the toner, and discharged through the paper outlet 15 out of the wet type printer 100.

The transfer unit 70 forms an image as follows, with the toner representing the printing information to be transferred to the recording paper P. Firstly a latent image is generated by the control unit 20 and the LSU 40. The LSU 40 is an example of exposure methods to form the latent image on the surface of the photoconductive drum 61, and includes a laser diode 41 serving as a light source, a collimator lens 42, a cylindrical lens 43, a polygon mirror 44, an image forming lens 45 and a deflecting mirror 46. Here, an LED (Light Emitting Diode) or a reducing optical system may be employed as the exposure method, instead of the LSU 40.

The laser diode 41 emits a laser beam. The laser diode 41 is driven under the control of the control unit 20, so as to turn on and off (i.e., be modulated) according to the letter and image information inputted thereto. The laser beam emitted by the laser diode 41 enters the collimator lens 42 to be thereby converted from diffuse rays into parallel rays, and then enters the polygon mirror 44 via the cylindrical lens 43.

The laser beam converted into parallel rays is converged by the cylindrical lens 43 solely in an auxiliary scanning direction, near a reflecting surface of the polygon mirror 44. It is noted that the auxiliary scanning direction herein referred to designates a direction parallel to the sheet of FIG. 1 (a direction orthogonal to the rotating shaft of the photoconductive drum 61, i.e., a tangent on a circumferential surface thereof), while a direction orthogonal to the auxiliary scanning direction, i.e., a direction in which the laser beam is scanned on the photoconductive drum 61 (an axial direction on the photoconductive drum 61) is herein defined as a main scanning direction.

The polygon mirror 44 is rotated by a motor not shown, and hence the laser beam incident upon the polygon mirror 44 is deflected so as to scan in the main scanning direction. Then the laser beam incident upon the image forming lens 45 is thereby converted so as to scan in the main scanning direction at a predetermined speed on the photoconductive drum 61. The laser beam thus converted is deflected by the deflecting mirror 46 toward the photoconductive drum 61, to thereby form an image on the photoconductive drum 61. At this stage, since the laser beam is modulated with the progress of the main scanning, a scanning line according to the letter and image information is formed on the photoconductive drum 61. Also, since the photoconductive drum 61 rotates in the auxiliary scanning direction, a plurality of scanning lines is formed in the auxiliary scanning direction on the photoconductive drum 61. As a result, a two-dimensional latent image representing the letter and image information is generated on the photoconductive drum 61.

The developing unit 50 includes a developing solution tank 51, a developing solution carrier 52, a measuring roller (=developing solution applicator roller) 53, an adjusting blade 54, a developing roller 55, a developing roller charging corona 56, and a developing roller cleaning blade 58.

Close to the developing unit 50, there are located the photoconductive drum 61, on which a latent image is developed by the toner supplied by the developing roller 55 upon formation of the latent image by the LSU 40 based on the printing information, and a photoconductive drum charging corona 62 that uniformly charges the photoconductive drum 61. Also, there is located close to the developing unit 50 a photoconductive drum cleaning blade 63 for scraping off the toner remaining on the surface of the photoconductive drum 61 without being transferred to an intermediate transfer roll 71, to be later described, included in the transfer unit 70.

The developing solution tank 51, which serves as a housing sustaining the components of the developing unit 50, is capable of storing therein the developing solution DS. The developing solution tank 51 also receives the unconsumed toner that has been collected for recycling, as will be described later. Accordingly, the toner is unevenly distributed or aggregated in the developing solution DS in the developing solution tank 51. Here, the temperature of the developing solution stored in the developing solution tank 51 is controlled by a temperature control mechanism, which is not shown.

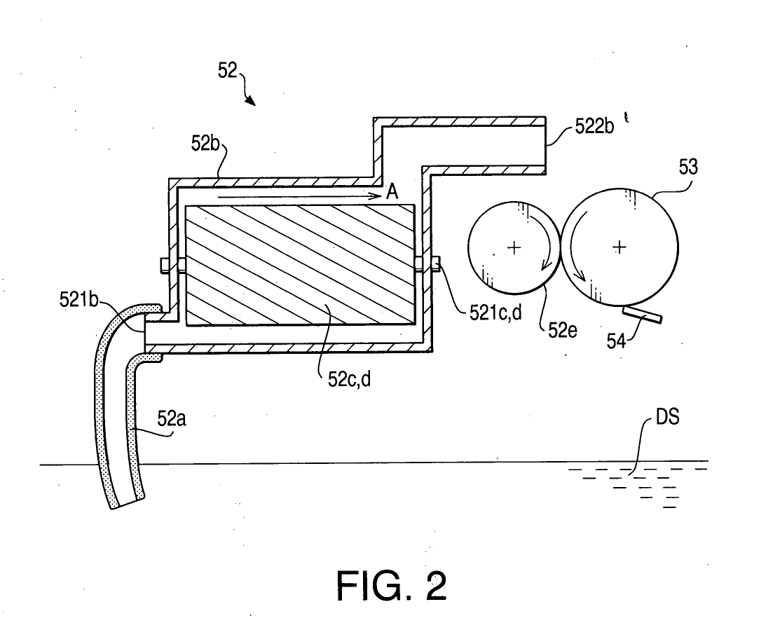

FIG. 2 is an enlarged cross-sectional side view showing a structure around a developing solution carrier according to the first embodiment. The developing solution carrier 52 includes a tube 52a, a housing 52b, helical gears 52c, 52d, and a supply roller 52e.

The tube 52a has one end portion disposed in the developing solution tank 51 so as to be dipped in the developing solution DS, and the other end portion connected to a portion of the housing 52b. The housing 52b is provided with two openings, namely an intake port 521b and a discharge port 522b. The intake port 521b is connected with the other end portion of the tube 52a. Accordingly, the developing solution DS in the developing solution tank 51 can flow through the tube 52a to be introduced into the housing 52b.

Inside the housing 52b, two helical gears 52c, 52d are retained in parallel with each other. The helical gears 52c, 52d are rotatably supported by the housing 52b via rotating shafts 521c, 521d, respectively.

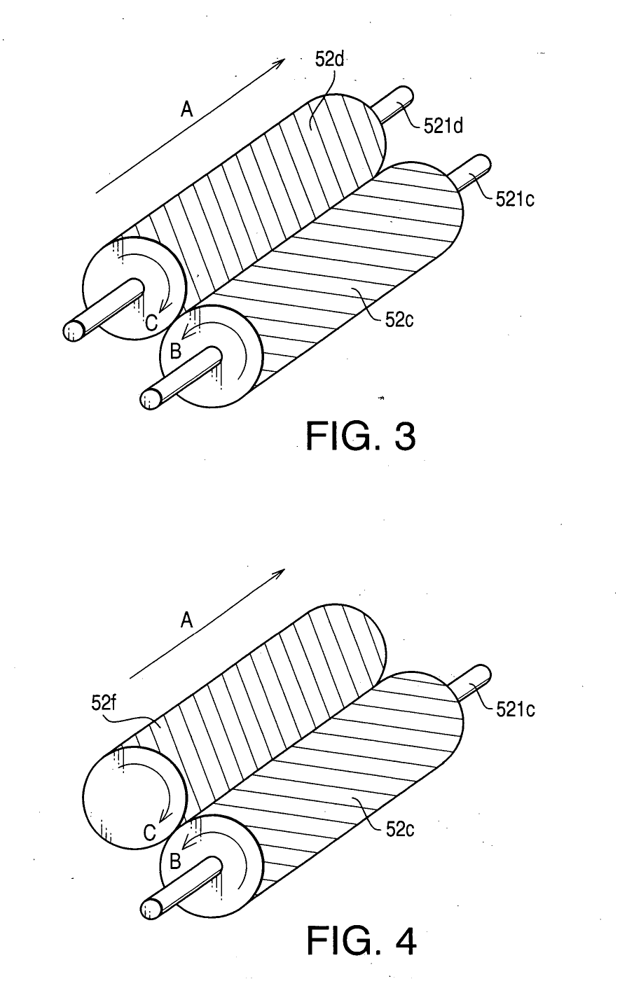

FIG. 3 is a schematic perspective view showing only the helical gears 52c, 52d and the rotating shafts thereof 521c, 521d out of the developing solution carrier 52 according to the first embodiment.

The helical gears 52c, 52d are of a cylindrical shape, and provided with a spiral tooth lead formed on the surfaces. The spiral tooth lead on the surface of the helical gear 52c and that on the surface of the helical gear 52d are formed in different directions. In the case, for example, where the spiral tooth lead on the surface of the helical gear 52c is directed clockwise, the spiral tooth lead on the surface of the helical gear 52d is directed counterclockwise.

The helical gears 52c, 52d are mutually engaged. The helical gear 52c is rotated by the driving unit 30 in a direction indicated by the arrow B. The helical gear 52d is caused to rotate by the rotation of the helical gear 52c, in a direction indicated by the arrow C.

When the helical gears 52c, 52d rotate, thrust force (shearing force) is generated at the interface therebetween in an axis direction (thrust direction) of these gears, i.e., in the direction of the arrow A. Such force introduces the developing solution DS in the developing solution tank 51 into the housing 52b through the tube 52a and the intake port 521b. The developing solution DS thus introduced is kneaded between the teeth of the helical gears 52c, 52d at a position where the teeth are mutually engaged, and flows inside the housing in the direction of the arrow A, taken along the spiral tooth lead. The toner in the developing solution DS is mixed to be uniformly distributed, and the toner that has been aggregated is diffused again, while the developing solution DS is being kneaded between the engaged teeth of the helical gears 52c, 52d. Thus, the developing solution DS is conveyed in the housing 52b in the direction of the arrow A while being mixed by the helical gears 52c, 52d.

It is to be noted that the helical gears 52c, 52d have diameters gradually increasing in the direction of the arrow A. Accordingly, the engagement ratio of the helical gears 52c, 52d gradually increases in a direction toward the discharge port 522b from the intake port 521b. Therefore, the developing solution DS is kneaded by greater force as the developing solution DS is conveyed farther inside the housing 52b. Such a configuration also serves to increase the load in the thrust direction, thereby ensuring the developing solution DS being conveyed in the direction of the arrow A. Actually, however, the increase in diameter of the helical gears 52c, 52d is very slight. Alternatively, the helical gears 52c, 52d may be formed in constant diameters so that the engagement ratio remains constant all the way.

The developing solution DS, which has been stirred and conveyed in the direction of the arrow A by the rotation of the helical gears 52c, 52d, is discharged through the discharge port 522b out of the housing 52b. The discharge port 522b is located above the supply roller 52e and the measuring roller 53. Accordingly, the developing solution DS which has been discharged through the discharge port 522b falls toward the supply roller 52e and measuring roller 53.

Thus, the developing solution carrier 52 according to the first embodiment has a simple structure, yet is capable of effectively mixing the developing solution DS and conveying the same to the measuring roller 53.

The supply roller 52e and the measuring roller 53 are rotatably butted to each other. Also, the supply roller 52e and the measuring roller 53 are provided with wall portions (not shown) on the respective end portions. The supply roller 52e, the measuring roller 53 and the wall portions thus disposed define a space that is widely open upward, between the supply roller 52e and the measuring roller 53. Since the developing solution DS discharged through the discharge port 522b falls into this space, and thereby pools between the supply roller 52e and the measuring roller 53, as shown in FIG. 2.

As shown in FIG. 2, the supply roller 52e rotates clockwise, while the measuring roller 53 rotates counterclockwise. When the developing solution DS stuck to the surface of the supply roller 52e in the aforementioned space passes through the rotation interface with the measuring roller 53, a portion of the developing solution DS falls in the developing solution tank 51, while the rest remains stuck to the supply roller 52e. In addition, the developing solution DS stuck to the surface of the measuring roller 53 in this space passes through the rotation interface with the supply roller 52e, and then reaches the position where the adjusting blade 54 is in contact with the measuring roller 53.

Then a portion of the developing solution DS stuck to the surface of the measuring roller 53 is scraped off (i.e., adjusted) by the adjusting blade 54 engaged with the measuring roller 53. It is noted that the measuring roller 53 is provided with a plurality of grooves formed at a predetermined interval on its surface. Accordingly, another portion of the developing solution DS stuck to the measuring roller 53 is exempted from being scraped off, since such portion is retained in the grooves. Therefore, it is only the portion retained in the grooves, i.e., the accurately adjusted portion of the developing solution DS, that remains on the surface of the measuring roller 53, and consequently the developing solution DS can be uniformly applied to the developing roller 55, which is in rotational contact with the measuring roller 53.

The developing solution DS contains the toner in a uniform concentration, immediately after the application to the developing roller 55 from the measuring roller 53. Accordingly, the toner is uniformly distributed in the carrier solution, in a region close to the interface between the measuring roller 53 and the developing roller 55. The developing roller 55 rotates in the clockwise direction, as shown in FIG. 1. Therefore, the developing solution DS having a uniform concentration is carried by the surface of the developing roller 55, thereby passing under the developing roller charging corona 56.

The developing roller 55 has a surface formed from a conductive material, so that such surface is uniformly charged by a corona charging effect of the developing roller charging corona 56. The charging effect generates an electric field between the surfaces of the developing roller 55 and the developing solution DS, and thereby causes the toner, which has been uniformly distributed in the carrier solution, to move toward the surface of the developing roller 55 and to closely stick thereto. In other words, the developing solution DS is split into two layers, namely a layer containing only the carrier solution and the other layer containing the toner in a higher concentration than the initial state in the carrier solution. Obviously, it is the latter layer that contacts the surface of the developing roller 55.

The developing solution DS split into two layers then reaches the position to contact the photoconductive drum 61. On the surface of the photoconductive drum 61, the latent image based on the printing information is formed by the beam outputted from the LSU 40. The photoconductive drum 61 is charged so as to gain a higher potential than the developing roller 55, by the photoconductive drum charging corona 62. However, the region where the latent image is provided based on the printing information by the laser beam gains a lower potential than the developing roller 55, because of an effect of the laser beam. Accordingly, between the region excluding the latent image on the photoconductive drum 61 and the surface of the developing roller 55, the toner remains closely stuck to the lower-potential region, i.e., the surface of the developing roller 55, without being transferred to the region where the latent image is not provided. Consequently, the region excluding the latent image is not developed. By contrast, between the latent image region on the surface of the photoconductive drum 61 and the surface of the developing roller 55, the toner is electrophoresed toward the lower-potential region, i.e., the latent image region on the surface of the photoconductive drum 61, thus to adhere thereto. Thereby, the latent image on the photoconductive drum 61 is developed, to turn into a toner image.

The developing solution DS containing the toner, which has not been utilized in the developing process, is scraped off by the developing roller cleaning blade 58 disposed in contact with the surface of the developing roller 55, and collected into the developing solution tank 51.

The toner image developed on the surface of the photoconductive drum 61 is transferred to the recording paper P by the transfer unit 70. The transfer unit 70 includes an intermediate transfer roll 71, a carrier solution squeeze roll 72, a carrier solution cleaning blade 73, a secondary transfer roll 74, and an intermediate transfer roll cleaning unit 75.

To the intermediate transfer roll 71, a transfer bias of a reverse polarity to the toner is applied, so that the toner image developed on the surface of the photoconductive drum 61 is primary-transferred to the intermediate transfer roll 71, at the interface between the photoconductive drum 61 and the intermediate transfer roll 71. At this stage, the portion of the toner remaining on the surface of the photoconductive drum 61 without being transferred at the interface is scraped off from the surface, by the photoconductive drum cleaning blade 63. Also, the carrier solution that has adhered to the surface of the intermediate transfer roll 71 together with the toner image is squeezed off from the surface by the carrier solution squeeze roll 72. Such residual carrier solution is then removed from the surface of the carrier solution squeeze roll 72 by the carrier solution cleaning blade 73, and is collected as waste toner in a waste toner box (not shown).

The intermediate transfer roll 71 and the secondary transfer roll 74 are disposed so as to oppose each other across the paper path for the recording paper P, and mutually butted at a predetermined nip pressure. The toner image transferred to the surface of the intermediate transfer roll 71 is transferred to the recording paper P to be carried along the paper path at the interface with the secondary transfer roll 74, by the effect of a transfer electric field, the nip pressure and so on. The intermediate transfer roll 71, interposed between the secondary transfer roll 74 and the photoconductive drum 61, also serves to prevent the nip pressure of the secondary transfer roll 74 from being directly applied to the photoconductive drum 61. Further, the toner that remains on the surface of the intermediate transfer roll 71 after the transference to the recording paper P is removed by the intermediate transfer roll cleaning unit 75, and is collected as waste toner in the aforementioned waste toner box.

The recording paper P on which the toner image has been transferred is carried to the fixing unit 80 along the paper path 14. The fixing unit 80 serves to apply heat and pressure to the recording paper P, so as to fix the toner image (i.e., the printing information) onto the recording paper P, and includes a heat roller 81 that heats up the recording paper P, and a press roller 82 that faces the heat roller 81 across the paper path and holds the recording paper P between itself and the heat roller 81 to apply a pressure to the recording paper P. The recording paper P, on which the image according to the printing information has been fixed by the fixing unit 80, is discharged through the paper outlet 15.

Although the present invention has been described based on the first embodiment, it is to be understood that the present invention is not limited thereto, but various modifications may be made without departing from the scope and spirit of the present invention.

Hereinafter, a few examples of the modifications of the present invention will be described with reference to the associated drawings. In the relevant drawings, the same constituents as those of the wet type printer 100 according to the first embodiment shown in FIGS. 1 to 3 are given identical reference numbers and detailed description thereof will be omitted.

### Second Embodiment

FIG. 4 is a schematic perspective view showing a helical gear 52c and a helical roller 52f incorporated in a wet type printer 100 according to another embodiment (second embodiment). The helical roller 52f is of a cylindrical shape, and provided with a spiral tooth lead formed on its surface. The spiral tooth lead on the surface of the helical gear 52f and that on the surface of the helical gear 52c are formed in different directions.

The helical roller 52f is not provided with a shaft member, and hence not pivotally supported by the housing 52b. However, an inner wall portion of the housing 52b is located along and close to the surface of the helical roller 52f. Accordingly, a gap between the inner wall portion of the housing 52b and the surface of the helical roller 52f is small. Such a configuration allows the helical roller 52f to rotate guided by the inner wall portion of the housing 52b, and thereby allows the helical gear 52c and the helical roller 52f to be mutually engaged. Consequently, when the helical gear 52c is rotated by the driving unit 30 in a direction of the arrow B, the helical roller 52f can be allowed to rotate in a direction of the arrow C, accompanied by the rotation of the helical gear 52c.

Adopting the helical roller 52f thus designed allows omitting the shaft member, resulting in reducing the manufacturing cost of the wet type printer 100. The helical roller 52f may be made of an elastic material. Employing an elastic material as the helical roller 52f causes an elastic deformation thereof, which achieves a closer contact between the helical roller 52f and the helical gear 52c. The closer contact of the helical roller 52f and the helical gear 52c enables kneading the developing solution DS with greater force.

### Third Embodiment

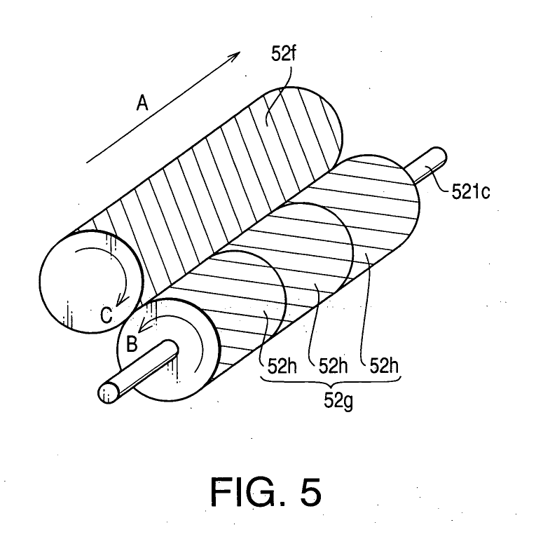

FIG. 5 is a schematic perspective view showing a helical gear 52g and a helical roller 52f incorporated in a wet type printer 100 according to a further embodiment (third embodiment). The helical gear 52g includes, for example, three pieces of helical gears 52h joined along a rotating shaft 521c. Each of the helical gears 52h has the same cross-sectional shape along a plane orthogonal to the rotating shaft 521c as that of the helical gear 52c according to the first embodiment, and an axial length corresponding to one third of the axial length of the helical gear 52c. In other words, the helical gear 52g including the three helical gears 52h has substantially the same outer shape as that of the helical gear 52c according to the first embodiment. Here, it is desirable to connect the helical gears 52h such that the tooth leads on the respective pieces are continuously aligned with one another.

Adopting the helical gear 52g thus designed allows utilizing a smaller mold, in the case of fabricating the helical gear 52h by resin molding, thereby reducing the fabricating and developing cost of the molding die.

The present disclosure relates to the subject matter contained in Japanese Patent Application No. P2004-334226, filed on Nov. 18, 2004, which is expressly incorporated herein by reference in its entirely.

What is claimed is:

1. A developing solution carrier configured to mix developing solution containing therein toner stored in a developing solution tank and convey the developing solution to a predetermined location, comprising:
a housing including a first opening connected to the developing solution tank and a second opening formed close to the predetermined location; and
two rotatable members located inside the housing,
wherein the rotatable members are configured to be engaged with each other, so as to generate force at the interface therebetween in a direction toward the second opening from the first opening while rotating.

2. The developing solution carrier according to claim 1,
wherein the rotatable members are cylindrical-shaped helical members having respective spiral tooth leads formed thereon, and
wherein at least one of the rotatable members is a helical gear supported by a rotatable shaft.

3. The developing solution carrier according to claim 2, wherein the rotatable members have the spiral tooth leads formed in different directions from each other.

4. The developing solution carrier according to claim 2, wherein the engagement ratio of the rotatable members is gradually increased in a direction toward the second opening from the first opening.

5. The developing solution carrier according to claim 1, wherein one of the rotatable members is caused to rotate by rotation of the other.

6. The developing solution carrier according to claim 1, wherein at least one of the rotatable members is formed of elastic material.

7. The developing solution carrier according to claim 1, wherein at least one of the rotatable members is configured with a plurality of rotatable members being joined to one another.

8. The developing solution carrier according to claim 1, wherein at least one of the rotatable members is formed by resin molding.

9. The developing solution carrier according to claim 2, wherein one of the rotatable members is caused to rotate by rotation of the other.

10. The developing solution carrier according to claim 2, wherein at least one of the rotatable members is formed of elastic material.

11. The developing solution carrier according to claim 2, wherein at least one of the rotatable members is configured with a plurality of rotatable members being joined to one another.

12. The developing solution carrier according to claim 2, wherein at least one of the rotatable members is formed by resin molding.

13. The developing solution carrier according to claim 3, wherein the engagement ratio of the rotatable members is gradually increased in a direction toward the second opening from the first opening.

14. The developing solution carrier according to claim 3, wherein one of the rotatable members is caused to rotate by rotation of the other.

15. The developing solution carrier according to claim 3, wherein at least one of the rotatable members is formed of elastic material.

16. The developing solution carrier according to claim 3, wherein at least one of the rotatable members is configured with a plurality of rotatable members being joined to one another.

17. The developing solution carrier according to claim 3, wherein at least one of the rotatable members is formed by resin molding.

18. A wet type image forming apparatus configured to form an image with developing solution containing toner in carrier solution stored in a developing solution tank, comprising:
a latent image carrying roller on which a latent image to be developed by the toner is formed;
a developing solution carrying roller configured to carry the developing solution so as to supply the toner to the latent image carrying roller;
a developing solution applicator roller configured to uniformly apply the developing solution to a surface of the developing solution carrying roller; and
a developing solution carrier configured to mix the developing solution in the developing solution tank and convey the developing solution toward the developing solution applicator roller,
wherein the developing solution carrier includes:
a housing including a first opening connected to the developing solution tank and a second opening formed above the developing solution applicator roller; and
two rotatable members located inside the housing, and
wherein the rotatable members are configured to be engaged with each other, so as to generate force at the interface therebetween in a direction toward the second opening from the first opening while rotating.

19. The wet type image forming apparatus according to claim 18,
wherein the rotatable members are cylindrical-shaped helical members having respective spiral tooth leads formed thereon, and
wherein at least one of the rotatable members is a helical gear supported by a rotatable shaft.

20. The wet type image forming apparatus according to claim 19, wherein the rotatable members have the spiral tooth leads formed in different directions from each other.
